(19) United States
(12) Patent Application Publication
(10) Pub. No.: US 2007/0256565 A1
(43) Pub. Date: Nov. 8, 2007

(54) Air filter restriction indicator

(76) Inventor: Chester J. Sohn, North Hollywood, CA (US)

Correspondence Address: LAW OFFICES OF MYOUNG K. LEE, 4 HUTTON CENTRE DRIVE ,STE 720, SANTA ANA, CA, 92707, US

(21) Appl. No.: 11/418,972

(22) Filed: May 5, 2006

(51) Int. Cl. B01D 46/00

(52) U.S. Cl. 96/417

(57) ABSTRACT

An air filter restriction indicator may comprise an indicator tab, a spindle inserted into the retention hole, a spindle-biasing member situated coaxial with the spindle, a tab-biasing member connected to the indicator tab; and a tab housing; wherein the indicator tab is adapted to extend through an indicator hole. The tab-biasing member may be adapted to move the indicator tab between a non-signaling position and a signaling position. The spindle may be situated within an effluent outlet for restraining the tab-biasing member from urging the indicator tab from the non-signaling position to the signaling position. The spindle is situated for subsequently releasing the indicator tab when pressure in the effluent outlet drops below a predetermined value relative to an ambient air pressure outside the filter housing.

### BACKGROUND OF THE INVENTION

1. Field of the Invention

This invention relates to an indicator for air filter restriction, in particular, to a visible and noticeable indicator for an air filtration apparatus that signals when air filter flow is restricted.

2. Description of the Prior Art

The function of an air intake filter is to remove the particulate matter from the intake air, so that clean air is provided to a desired location, such as an engine, a closed space for air-conditioning, clean rooms, breathing apparatuses (such as gas masks for atomic, biological, and/or chemical contaminants), and the like. The intake air stream flows from the influent, or “dirty,” side of the filter to the effluent, or “clean,” side of the filter, with the air filter extracting the unwanted particles via one or more filter media layers. Filter media are selected to trap particles exceeding a particular size, while remaining substantially permeable to airflow over an expected filter lifetime.

The features and filter design choices that lead to improvements in one of these parameters (e.g., particle entrapment, airflow permeability, and filter lifetime) can lead to declines in the other performance parameters. Thus, filter design involves trade-offs among features achieving high filter efficiency, and features achieving a high filter capacity and concomitant long filter lifetime.

As used herein, filter efficiency is the propensity of the lifter media to trap, rather than pass, particulates. Filter capacity is typically defined according to a selected limiting pressure differential across the filter, typically resulting from loading by trapped particulates. Volumetric filter flow rate, or flow rate, is a measure of the volume of air that can be drawn into the filter having a particular effective filter area, efficiency, and capacity, at a particular point in the expected filter lifetime.

The choice of filter media that has a high filter efficiency (wherein the filter media removes a high percentage of the particulate material in the intake air) is important, because any particulate matter passing through the filter may harm the engine. For systems of equal efficiency, a longer filter lifetime typically is directly associated with higher capacity, because the more efficiently the filter medium removes particles from an air stream, the more rapidly that filters medium approaches the pressure deferential indicating the end of the filter medium life. To extend filter lifetime, filter media can be pleated to provide greater filtering surface area.

The choice of air filter media that is permeable to airflow is important because the interposition of the filter into the intake air stream can impede the flow rate. This tends to decrease engine efficiency, horsepower, torque, and fuel economy when using an air filter for treating engine intake air. In applications demanding large volumes of filtered air, the ability to manipulate parameters such as air filter size, pleat depth, or both, is often constrained additionally by the physical environment in which the filter is operated (e.g. the space available for a filter of a given configuration within the engine compartment).

When using an air filter, it is difficult to determine when the air filter needs changing. Often, the apparatus, compressor, or other device must be shut down to remove and check the filter visually. Also, mere visual inspection is not always accurate for determining the amount of dirt already trapped by the filter and whether the filter needs changing. Changing a filter too often (such as by prematurely removing filter still usable) can lead to waste. Changing a filter too seldom (such as by removing a filter long after the usefulness is expired) can lead to poor performance, such as restricted air intake flow or noxious odors entering a ventilation system from excess particulates trapped in a filter.

As can be seen, there is a need for an improved filtration apparatus with an indicator to demonstrate when air flow is restricted through a filter because of excess particulates trapped in the filter. Furthermore, there is a need for an improved filter restriction indication apparatus that is easily recognizable without having to shut down a machine, such as an engine, motor, air conditioner, and the like.

### SUMMARY OF THE INVENTION

In one aspect of the present invention, an air filter restriction indicator comprises an indicator tab with a retention hole; a spindle inserted into the retention hole; a spindle-biasing member situated coaxial with the spindle; a tab-biasing member connected to the indicator tab; and a tab housing with an indicator hole; wherein the indicator tab is adapted to extend through the indicator hole.

In another aspect of the present invention, an apparatus for filtering air comprises a filter housing having an influent side with an end plate at the influent side; and a filter element situated within the filter housing; a filter inlet passage situated between the filter housing and the filter element; an effluent outlet situated at the influent side of the filter housing; a tab housing opposite the influent side of the filter housing; an indicator tab situated within the tab housing; a tab-biasing member connected to the indicator tab, the tab-biasing member adapted to move the indicator tab from a non-signaling position in which the indicator tab does not extend noticeably from the tab housing and a signaling position in which the indicator tab extends noticeably from the tab housing; and a spindle situated within the effluent outlet for restraining the tab-biasing member from urging the indicator tab from the non-signaling position to the signaling position; wherein the spindle is situated for subsequently releasing the indicator tab when pressure in the effluent outlet drops below a predetermined value relative to ambient air pressure outside the filter housing.

In yet another aspect of the present invention, an apparatus for filtering air comprises a filter housing having an influent side; a filter element situated within the filter housing; a filter inlet passage situated between the filter housing and the filter element; an effluent outlet situated at the influent side of the filter housing; a tab housing opposite the influent side of the filter housing; an indicator tab situated within the tab housing; a tab-biasing member connected to the indicator tab, the tab-biasing member adapted to move the indicator tab from a non-signaling position in which the indicator tab does not extend noticeably from the tab housing and a signaling position in which the indicator tab extends noticeably from the tab housing; and a spindle situated within the effluent outlet for restraining the tab-biasing member from urging the indicator tab from the non-signaling position to the signaling position; wherein the spindle comprises a plurality of grooves for engaging the spindle-biasing member, the shape, position, and number of grooves corresponding to a situation when the spindle releases the indicator tab when pressure in the effluent outlet drops below a predetermined value relative to ambient air pressure outside the filter housing.

These and other features, aspects and advantages of the present invention will become better understood with reference to the following drawings, description, and claims.

### BRIEF DESCRIPTION OF THE DRAWINGS

FIG. 1 is a cross-sectional elevation view of an apparatus for filtering air with an air filter restriction indicator in a non-signaling position, according to an embodiment of the present invention;

FIG. 2 is a cross-sectional elevation view of the apparatus for filtering air shown in FIG. 1, with the air filter restriction indicator in a signaling position;

FIG. 3 is a cross-sectional elevation view of the apparatus for filtering air, according to another embodiment of he present invention;

FIG. 4 is a cross-sectional elevation view of an apparatus for filtering air, according to yet another embodiment of the present invention;

FIG. 5 is an exploded view of an air filter restriction indicator, according to another embodiment of the present invention;

FIG. 6 is a perspective view of an air filter restriction indicator, according to yet another embodiment of the present invention with an air filter restriction indicator in a non-signaling position;

FIG. 7 is a perspective view of the air filter restriction indicator, shown in FIG. 4, with the air filter restriction indicator in a signaling position;

FIG. 8 is a perspective view of the tab housing and indicator tab shown in FIG. 7;

FIG. 9 is a bottom view of the tag housing and indicator tab shown in FIG. 8;

FIG. 10 is a perspective view of the tab housing, without the indicator tab shown in FIG. 7;

FIG. 11 is a perspective view of the grommet in FIG. 6, with the tab housing removed;

FIG. 12 is an exploded view of the grommet in FIG. 11, with the spindle removed;

FIG. 13 is a bottom view of the grommet in FIG. 12;

FIG. 14 is a perspective view of the indicator tab and a tab-biasing member shown in FIG. 5;

FIG. 15 is a bottom view of the indicator tab;

FIG. 16 is a top view of the indicator tab;

FIG. 17 is a perspective view of the spindle shown in FIG. 11.

### DETAILED DESCRIPTION OF THE INVENTION

The following detailed description is of the best currently contemplated modes of carrying out the invention. The description is not to be taken in a limiting sense, but is made merely for the purpose of illustration the general principles of the invention, since the scope of the invention is best defined by the appended claims.

Broadly, the present invention provides an air filtration system for the intake portion of a system requiring air, such as an internal combustion engine. It is to be understood that the present invention may also be useful for any system requiring particulates to be removed from air, such as for ventilation systems, air conditioning systems, gas masks, clean room environments, and the like.

An embodiment of the present invention may be distinguished from the prior art in its overall configuration, in which a spindle is situated within the effluent outlet of a filter for restraining a tab-biasing member (such as a spring) from urging an indicator tab from a non-signaling position to a signaling position. The spindle comprises a plurality of grooves or protuberances for engaging the spindle-biasing member. The shape, position, and number of grooves or protuberances may correspond to a situation when the spindle releases the indicator tab when pressure in the effluent outlet drops below a predetermined value relative to ambient air pressure outside the filter. Various different air filters may require various different grooves (or protuberance), shapes, positions, and/or number for proper indication of when an air filter is clogged. The air filter is often considered clogged with particulates when the air effluent pressure drops below a predetermined value, creating a vacuum that draws the spindle down away from the indicator tab. The tab-biasing member may also be formed in a specific configuration to match particular air filter specifications to push the indicator tab outwards when the air filter is clogged.

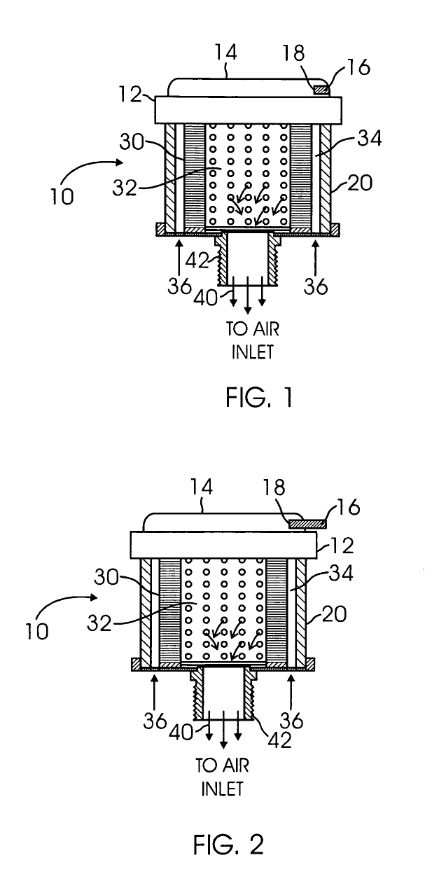

In FIG. 1, an apparatus 10 for filtering air is shown to have a filter housing 20. The filter housing 20 may be comprised of metal, such as cold rolled steel (painted or powder coated), or stainless steel.

In operation, inlet air (such as ambient air) 32 may pass through filter inlet passage 34 for filtration with filter element 30 passing, as indicated by the arrows in the figure, from inside a downstream portion 32 of the filter 30 and exiting at the effluent outlet 42 as filtered intake air 40. Filtered intake air 40 may then proceed to an air inlet and later directed where needed such as to each cylinder of an internal combustion engine (not shown). The apparatus 10, including the filter element 30 and the filter housing 20 may be of various shapes, such as right-cylindrical, conical-shaped, rectangular, or any suitable shape. “Conical shaped” is here used to mean a tapered or generally conical-shaped surface not restricted to having only a circular cross section, but which may, for example, have an oval or even rectangular-shaped cross section.

The filter element 30 may comprise a paper, a natural fiber fabric (such as cotton mesh fabric or oleophilic cotton mesh), or any suitable media. The filter element 30 may be pleated. The filter element 30 may be oil-wetted using an efficacious amount of oil for increasing airborne particle trapping.

Continuing with FIG. 1, a tab housing 14 may be connected to the filter housing 20 via a grommet 12. An indicator tab 16 may be in non-signaling position (such as not extending through or out from an indicator hole 18). A spindle 56 (not shown) may be engaged with, or otherwise connected to, the indicator tab 16 (as described below) such that the spindle 56 (not shown) is responsive to a change in pressure.

As shown in FIG. 2, if the filter element 30 becomes clogged with dirt or other particulates, then a vacuum may occur within the filter housing 20. The spindle 56 (no shown) may be situated within the effluent outlet 42 for restraining a tab-biasing member (described below) from urging the indicator tab 16 from the non-signaling position (shown in FIG. 1) to the signaling position (shown in FIG. 2). The spindle 56 (not shown) may subsequently release the indicator tab 16 when the pressure in the effluent outlet 42 drops below predetermined value relative to ambient air pressure outside the filter housing 20. The figures are not necessarily drawn to scale. For example, the present invention may include any suitable relative sizes of components.

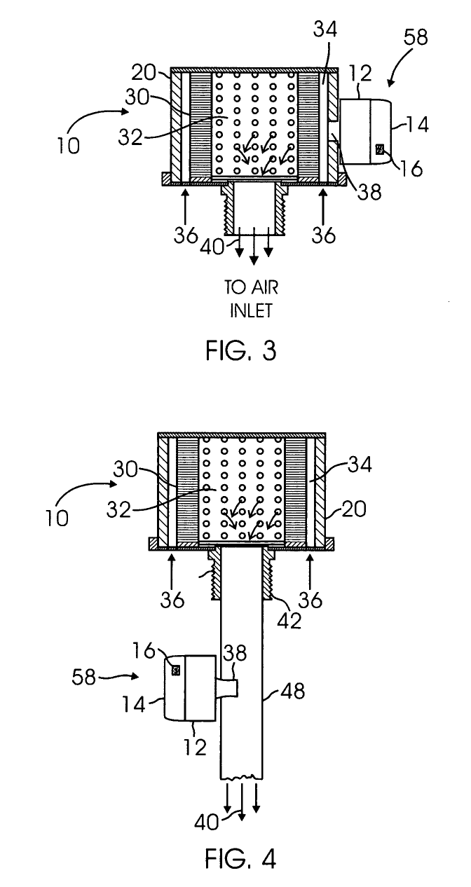

AIR FILTER RESTRICTION INDICATOR 58 may be situated at any suitable location within the apparatus 10. For example, the air filter restriction indicator 58 may be situated such that the vacuum channel 38 is located within the filter housing 20, within fluid communication with the filter element 30, as shown in FIG. 3. The present invention, the air filter restriction indicator 58 may be located in locations other than as shown in FIG. 3.

FIG. 4 shows another embodiment of the present invention. A filtered air tubing 48 may be situated inside the effluent outlet. The air filter restriction indicator 58 may also be placed into the filtered air tubing 48 for fluid communication with the filter element 30. As described the above regarding FIG. 2, if the filter element 30 becomes clogged the indicator tab 16 may be urged from a non-signaling position to a signaling position (or form a signaling position to a non-signaling position when replacing the filter element 30).

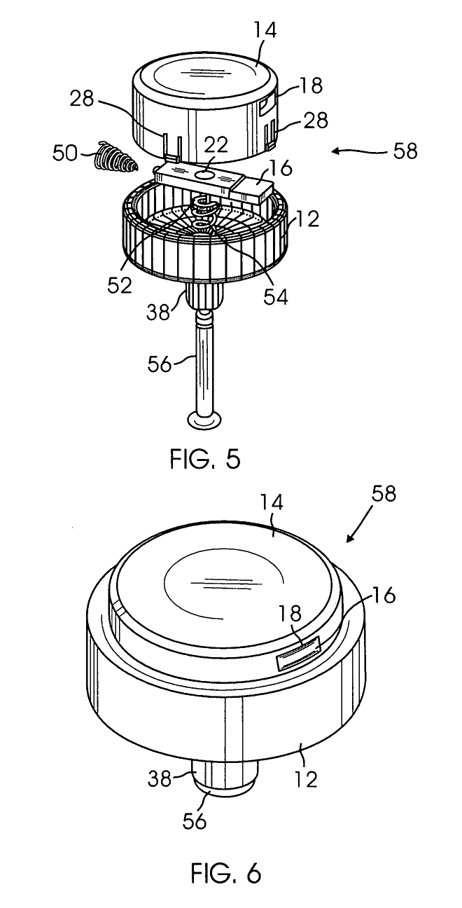

An embodiment of the present invention may be further understood in reference to FIG. 5, which is an exploded view of an air filter restriction indicator. The tab housing 14 may hold the tab indication 16. A plurality of snap tabs 28 may be present for securing the tab housing 14 to the grommet 12.

A tab-biasing member (such as a spring) 50 may serve to urge the tab indicator 16 to extend out from the tab housing 14, such as through the indicator hole 18. The spindle 56 may be connected (such as being releasably attached) to the tab indicator 16 to counteract the urging force the tab-biasing member 50. The tab-biasing member 50 may be adapted to move the indicator tab 16 from a non-signaling position (shown in FIG. 1) in which the indicator tab 16 does not extend noticeably from the tab housing 14 (such as through the indicator hole 18) and a signaling position (shown in FIG. 2) in which the indicator tab 16 extends noticeably from the tab housing 14 (such as through the indicator hole 18).

A C-clip 52 and a spindle-biasing member (such as a spring) 54 may be used to engage the spindle 56 orthogonally from the tab indicator 16 to restrain the tab indicator 16 from extending laterally through the indicator hole 18. The spindle-biasing member 54 may act on the spindle 56 to hold the indicator tab 16 in a non-signaling position to detain the tab-biasing member 50 from urging the indicator tab 16 through the indicator hole 18. A vacuum channel 38 may serve to guide the spindle 56 and to communicate vacuum pressure between the interior of the filter housing 20 (shown in FIGS. 1 and 2) and the interior of the tab housing 14.

In more specifically describing the present invention, and as can be appreciated from FIG. 6, an air filter restriction indicator 58 (without a filter attached), according to yet another embodiment of the present invention is shown with an air filter restriction indicator 58 in a non-signaling position. The spindle 56 is not lowered as the spindle 56 is engaged with the tab indicator 16 to detain the tab indicator 16 in the non-signaling position.

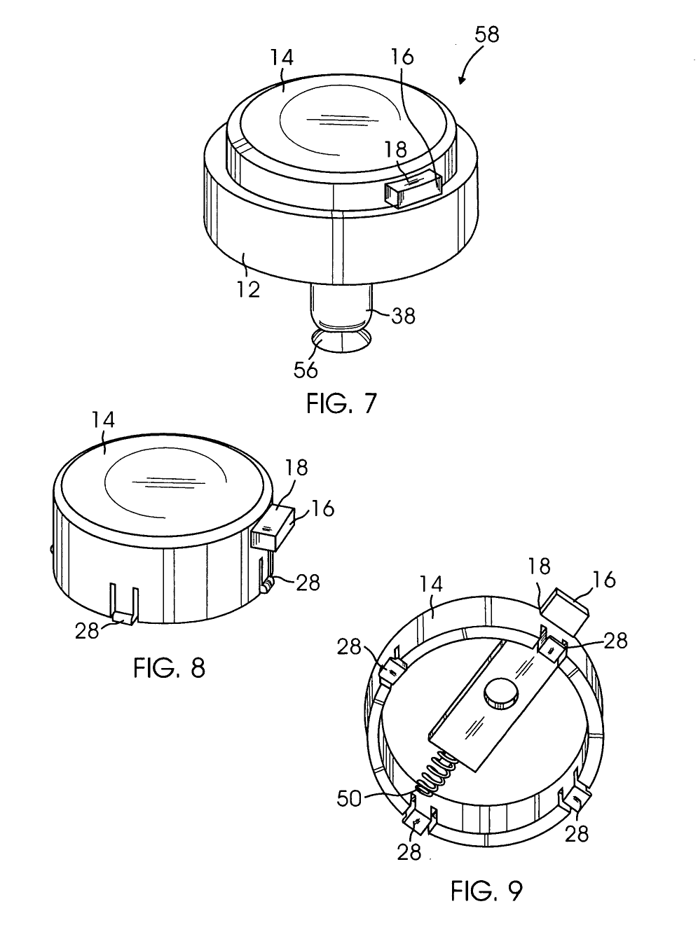

As shown in FIG. 7, the air filter restriction indicator 58 is shown with the tab indicator 16 in a signaling position. The spindle 56 is lowered (away from the tab housing 14) as the spindle 56 is no longer engaged with the tab indicator 16 to detain the tab indicator 16 in the non-signaling position. Because the filter (not shown) is clogged, a vacuum is induced within the filter housing (shown in FIGS. 1 and 2). The spindle 56 and the spindle-biasing member 54 may be pressure responsive such that the vacuum causes the spindle 56 to retract away from a retention hole 22 (shown in FIG. 5) in the tab indicator 16, permitting the tab indicator 16 to be urged by the tab-biasing member 50 such that the tab indicator 16 extends through the indicator hole 18.

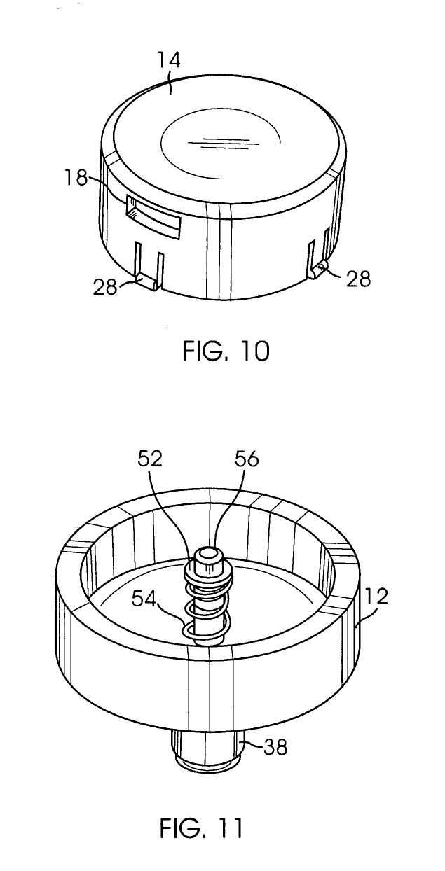

The tab housing 14 in FIG. 7 is shown in isolation in FIG. 8. The underside of the tab housing 14 is shown in FIG. 9. FIG. 10 is a perspective view of the tab housing 14, without the indicator tab 16 shown in FIG. 7. The tab housing 8 may be made from injection-molded plastic or any other durable material.

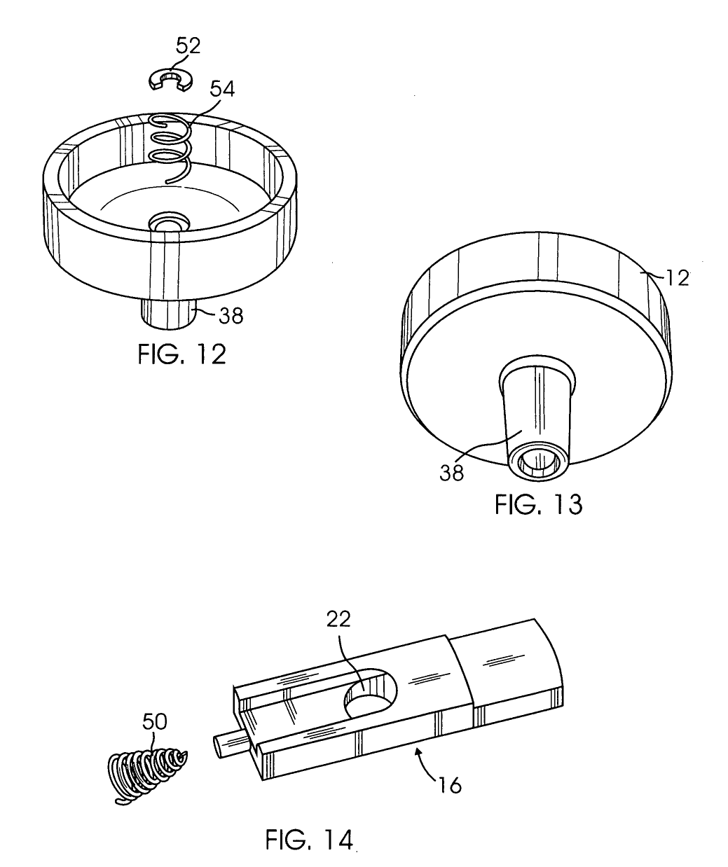

FIG. 11 is a perspective view of the grommet 12 in FIG. 6, with the tab housing 14 removed. The grommet 12 may be made from durable, but flexible material, such as plastic, rubber, or any other suitable material. The spindle-biasing member 54 biases the spindle 56 to keep the spindle 56 in position. FIG. 12 is an exploded view of the grommet 12 in FIG. 11, with the spindle 56 removed. FIG. 13 is a bottom view of the grommet in FIG. 12.

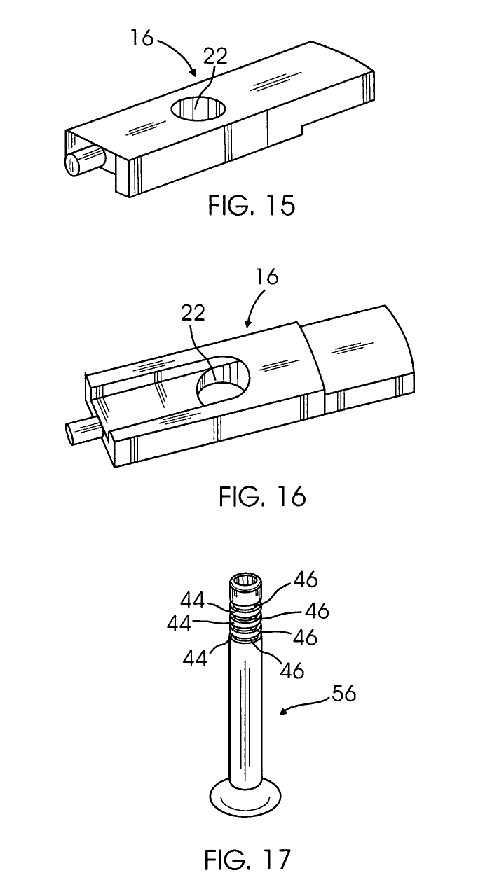

The indicator tab 16 is shown in FIG. 14 in conjunction with the tab-biasing member 50. In FIG. 16, the indicator tab 16 is shown in isolation. The indicator tab 16 may be made from metal, plastic, rubber, or any other suitable material. The underside of the indicator tab 16 is shown in FIG. 15.

FIG. 17 shows, in isolation, the spindle 56. The spindle 56 may be made from metal, plastic, rubber, or any other suitable material. A plurality of protuberances (such as ridges, bumps, and the like) 44 and/or a plurality of grooves 46 may be situated on the spindle 56 for engaging the spindle-biasing member 54 (shown in FIGS. 5 and 11) and/or the retention hole 22 of the indicator tab 16 (shown FIGS. 14-16). The shape, position, and number of grooves and/or protuberances may be configured to correspond to a situation when the spindle 56 releases the indicator tab 16 (shown in FIG. 5) when pressure in the effluent outlet 42 (shown in FIGS. 1 and 2) drops below a predetermined value relative to ambient air pressure outside the filter housing 20 (shown in FIGS. 1 and 2).

It should be understated, of course, that the foregoing relates to exemplary embodiments of the invention and that modifications may be made without departing from the spirit and scope of the invention as set forth in the following claims. For example, the invention is not exclusively suitable for use with internal combustion engines, but for all uses requiring filtration of air.

I claim:

1. An air filter restriction indicator, comprising:
an indicator tab with a retention hole;
a spindle inserted into said retention hole;
a spindle-biasing member situated coaxial with said spindle;
a tab-biasing member connected to said indicator tab; and
a tab housing with an indicator hole;
wherein said indicator tab is adapted to extend through said indicator hole.

2. The air filter restriction indicator of claim 1, wherein said spindle-biasing member holds said indicator tab in a non-signaling position to detain said tab-biasing member from urging said indicator tab through said indicator hole.

3. The air filter restriction indicator of claim 1, wherein said spindle-biasing member is a spring.

4. The air filter restriction indicator of claim 1, wherein said tab-biasing member is a spring.

5. The air filter restriction indicator of claim 1, wherein said tab-biasing member is adapted to move said indicator tab from a non-signaling position in which said indicator tab does not extend noticeably through said indicator hole and a signaling position in which said indicator tab extends noticeably through said indicator hole.

6. The air filter restriction indicator of claim 1, wherein said spindle is releasably attached to said indicator tab.

7. An apparatus for filtering air, comprising:
a filter housing having an influent side with an end plate at the influent side;
a filter element situated within said filter housing;
a filter inlet passage situated between the filter housing and the filter element;
an effluent outlet situated at the influent side of the filter housing;
a tab housing opposite the influent side of the filter housing;
an indicator tab situated within said tab housing;
a tab-biasing member connected to said indicator tab, said tab-biasing member adapted to move said indicator tab from a non-signaling position in which said indicator tab does not extend noticeably from said tab housing and a signaling position in which said indicator tab extends noticeably from said tab housing; and
a spindle situated within the effluent outlet for restraining said tab-biasing member from urging said indicator tab from the non-signaling position to the signaling position;
wherein said spindle is situated for subsequently releasing said indicator tab when pressure in the effluent outlet drops below a predetermined value relative to ambient air pressure outside the filter housing.

8. The apparatus of claim 7, wherein said spindle is releasably attached to said indicator tab.

9. The apparatus of claim 7, wherein the signaling position comprises said indicator tab extending through a hole in said tab housing.

10. The apparatus of claim 7, wherein said tab housing is connected to the filter housing via a grommet.

11. The apparatus of claim 7, wherein the filter housing comprises cold rolled steel (painted or powder coated) or stainless steel.

12. The apparatus of claim 7, wherein said filter housing is cylindrical.

13. The apparatus of claim 7, wherein said spindle comprises a plurality of protuberances for engaging said tab-biasing member.

14. The apparatus of claim 7, wherein said spindle further comprises a plurality of grooves for engaging said tab-biasing member.

15. An apparatus for filtering air, comprising:
a filter housing having an influent side;
a filter element situated within the filter housing;
a filter inlet passage situated between the filter housing and the filter element;
an effluent outlet situated at the influent side of the filter housing;
a tab housing opposite the influent side of the filter housing;
an indicator tab situated within said tab housing;
a tab-biasing member connected to said indicator tab, said tab-biasing member adapted to move said indicator tab from a non-signaling position in which said indicator tab does not extend noticeably from said tab housing and a signaling position in which said indicator tab extends noticeably from said tab housing; and
a spindle situated within the effluent outlet for restraining said tab-biasing member from urging said indicator tab from the non-signaling position to the signaling position.
Wherein said spindle comprises a plurality of grooves for engaging said spindle-biasing member, the shape, position, and number of grooves corresponding to a situation when said spindle releases said indicator tab when pressure in the effluent outlet drops below a predetermined value relative to ambient air pressure outside the filter housing.

16. The apparatus of claim 15, wherein the signaling position comprises said indicator tab extending through a hole in said tab housing.

17. The apparatus of claim 15, wherein said tab housing is connected to the filter housing via grommet.

18. The apparatus of claim 15, wherein the filter housing comprises cold rolled steel (painted of powder coated) or stainless steel.

19. The apparatus of claim 15, wherein the filter housing is cylindrical.
